(19) United States
(12) Patent Application Publication
(10) Pub. No.: US 2018/0036846 A1
(43) Pub. Date: Feb. 8, 2018

(54) FLEXIBLE MECHANISM AND GANTRY DEVICE HAVING THE SAME

(71) Applicant: HIWIN MIKROSYSTEM CORP., Taichung City (TW)

(72) Inventors: Chang-Cheng HO, Taichung City (TW); Yi-Wen CHEN, Taichung City (TW)

(21) Appl. No.: 15/228,726

(22) Filed: Aug. 4, 2016

(51) Int. Cl. B23Q 1/01; B23Q 11/00

(52) U.S. Cl. CPC B23Q 1/012; B23Q 11/001

(57) ABSTRACT

A flexible mechanism and a gantry device having the same are provided. The flexible mechanism serves to compensate the positional space error caused by synchronous error, deformation or the like factor of the gantry beam. The flexible members serve to enhance the rigidity in the direction of the motional axis, in which the external force is applied to the beam. This can avoid hysteresis phenomenon of the beam during operation.

### BACKGROUND OF THE INVENTION

### 1. Field of the Invention

The present invention relates generally to a machine tool, and more particularly to a flexible mechanism and a gantry device having the same.

### 2. Description of the Related Art

Due to the limitation of structural rigidity, manufacturing, assembling and control technique, the geometrical error or space error of a machine tool during operation is inevitable. In order to minimize the affection of the positional error during operation, many conventional techniques or systems have been developed to compensate the error. For example, a laser interferometer can be used to rectify the motional path and lower or eliminate the error. Alternatively, a cushioning or deformation technique can be used to avoid motional error so as to eliminate the improper torque or stress applied to the machine tool.

Specifically, as shown in FIG. 1, the conventional gantry device 1 has a beam member 3 bridged over the bed seat 2. One side of the beam member 3 has a deformable flexible mechanism 4. Accordingly, when an error of relative motion between two ends of the beam member 3 and the bed seat 2 takes place, the flexible mechanism 4 allows the positional/angular change of the beam member 3 caused by the synchronous error so as to avoid the improper stress applied to the beam member 3. In such technique, the rigidity of the flexible mechanism 4 is weakened to allow the deformation so as to achieve an expected object. However, the low rigidity of the flexible mechanism 4 will lead to hysteresis phenomenon of the beam 3 in motion. This needs to be improved.

### SUMMARY OF THE INVENTION

It is therefore a primary object of the present invention to provide a flexible mechanism with high axial-rigidity and a gantry device having the flexible mechanism. The flexible mechanism serves to deform for compensating the error of the position of the gantry beam. Also, the flexible mechanism has higher rigidity in the direction of a motional axis of the gantry beam. This eliminates the problem of motional hysteresis or error reoccurrence of the beam due to insufficient rigidity of the flexible mechanism.

To achieve the above and other objects, the flexible mechanism of the present invention includes multiple flexible members. The flexible members are deformable and have higher rigidity in the direction of the motional axis.

“The flexible members have higher rigidity in the direction of the motional axis” means that the rigidity of the flexible members in the direction of the motional axis is higher than the rigidity of the flexible members in a direction different from the direction of the motional axis.

The rigidity of the flexible members in the direction of the motional axis is enhanced in such a manner that the flexible members with same rigidity are arranged by different arrangement density or different angle. Therefore, the flexible members have different rigidities in different directions. Alternatively, different flexible members with different rigidities can be respectively arranged to enhance the rigidity in a specific direction.

In practice, the flexible mechanism includes a first connection member; a second connection member spaced from the first connection member, the first connection member and the second connection member being relatively movable in the direction of a first axis; a first flexible member positioned in the direction of the first axis and bridged between the first connection member and the second connection member, the first flexible member being deformable with the relative displacement between the first connection member and the second connection member; and a second flexible member positioned in a direction different from the direction of the first axis and bridged between the first connection member and the second connection member. According to the above arrangement, the rigidity of the first flexible member is larger than the rigidity of the second flexible member for enhancing the anti-deformation ability of the first flexible member in the direction of the first axis.

In the above flexible mechanism, the first connection member has an open end. The second connection member is positioned in the open end of the first connection member. The first connection member and the second flexible member are positioned between inner wall of the open end of the first connection member and the second connection member.

In the above flexible mechanism, the arrangement density of the first flexible member is larger than the arrangement density of the second flexible member.

In the above flexible mechanism, the first flexible member and the second flexible member are leaf springs.

In the above flexible mechanism, the first connection member and the second connection member are further relatively movable in the direction of a second axis. The rigidity of the second flexible member in the direction of the second axis is larger than the rigidity of the second flexible member in a direction different from the direction of the second axis.

In the above flexible mechanism, the first flexible member and the second flexible member respectively have different thicknesses.

The flexible mechanism of the present invention is applied to a gantry device. Substantially, the gantry device includes a first flexible mechanism. The first flexible mechanism includes a first connection member, a second connection member, a first flexible member and a second flexible member. The first connection member and the second connection member are respectively disposed on a beam member of the gantry device and relatively movable. Accordingly, when the first connection member and the second connection member are driven by the beam member to relatively move, the first flexible member is deformed.

In accordance with the space positional change of the beam member, the gantry device further includes a second flexible mechanism. The first flexible mechanism and the second flexible mechanism are respectively disposed at two ends of the beam member. The second flexible mechanism includes a third connection member, a fourth connection member, a third flexible member and a fourth flexible member. The fourth connection member is spaced from the third connection member. The third connection member and the fourth connection member are relatively movable in the direction of the first axis. The third flexible member is positioned in the direction of the first axis and bridged between the third connection member and the fourth connection member. The third flexible member is deformable with the relative displacement between the third connection member and the fourth connection member. The fourth flexible member is positioned in a direction different from the direction of the first axis and bridged between the third connection member and the fourth connection member. According to the above arrangement, the rigidity of the third flexible member is larger than the rigidity of the fourth flexible member for enhancing the anti-deformation ability of the third flexible member in the direction of the first axis.

In the above gantry device, the first connection member and the third connection member are respectively fixedly disposed at two ends of the beam body and the second connection member and the fourth connection member are respectively attached to the slide connection members.

In the above gantry device, the first connection member and the second connection member of the first flexible mechanism are further relatively movable in the direction of a second axis. The third connection member and the fourth connection member of the second flexible mechanism are further relatively movable in the direction of the second axis. The rigidity of the second flexible member of the first flexible mechanism in the direction of the second axis is unequal to the rigidity of the fourth flexible member of the second flexible mechanism in the direction of the second axis. Therefore, the first flexible mechanism and the second flexible mechanism have different rigidities in different directions in adaptation to the positional error change of the beam member in different directions. In this case, when the beam member moves on a plane, the rotation and extension/retraction caused by the synchronous error can be compensated. Also, the space positional change of the beam member caused by the deformation under thermal expansion/contraction can be compensated.

In the above gantry device, the third connection member has an open end. The fourth connection member is positioned in the open end of the third connection member. The third flexible member and the fourth flexible member are positioned between inner wall of the open end of the third connection member and the fourth connection member.

The present invention can be best understood through the following description and accompanying drawings, wherein:

### BRIEF DESCRIPTION OF THE DRAWINGS

FIG. 1 is a perspective view of a conventional gantry device;

FIG. 2 is a perspective view of an embodiment of the gantry device of the present invention;

FIG. 3 is a front view of the embodiment of the gantry device of the present invention;

FIG. 4 is a perspective view of the first flexible mechanism of the embodiment of the gantry device of the present invention;

FIG. 5 is a perspective view of the second flexible mechanism of the embodiment of the gantry device of the present invention;

FIG. 6 is a top view of the embodiment of the gantry device of the present invention;

FIG. 7 is a plane view of the second flexible mechanism of another embodiment of the gantry device of the present invention; and

FIG. 8 is a plane view of the first flexible mechanism of another embodiment of the gantry device of the present invention.

### DETAILED DESCRIPTION OF THE PREFERRED EMBODIMENTS

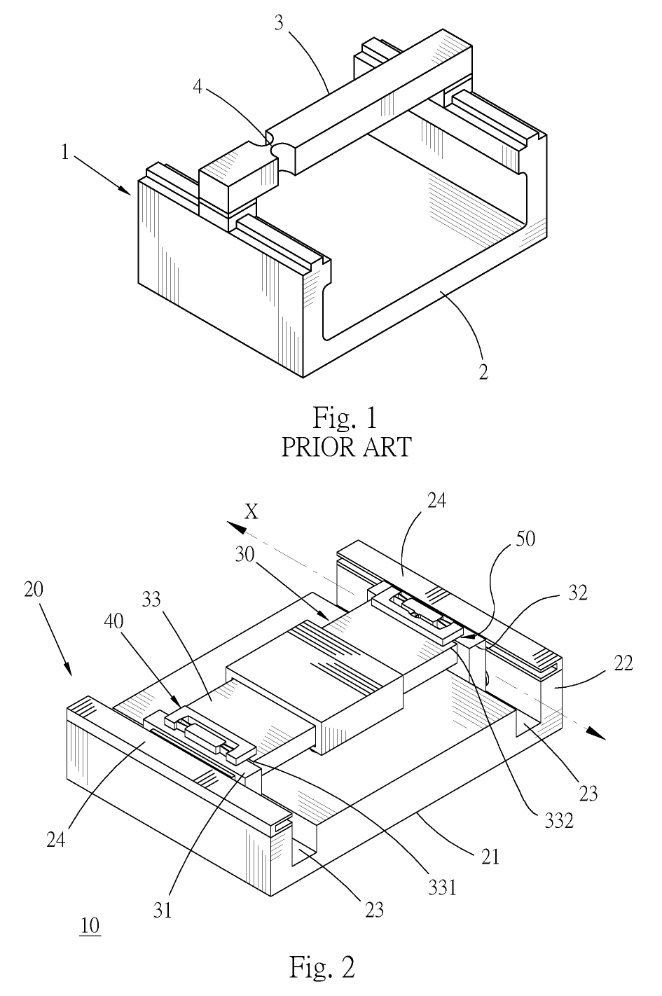

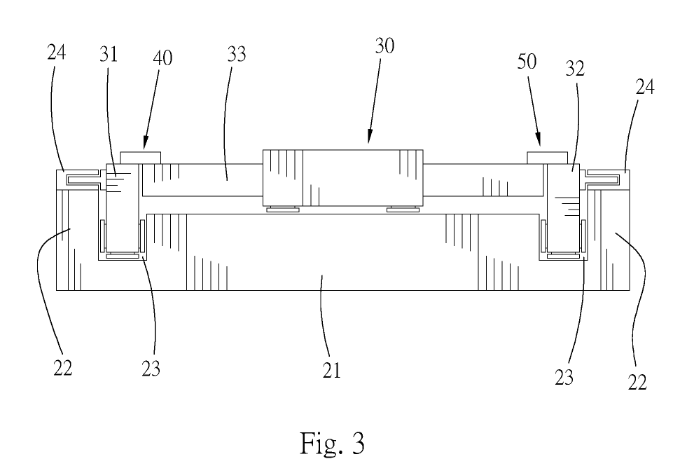

Please refer to FIGS. 2 and 3. According to an embodiment, the gantry device 10 of the present invention mainly includes a seat 20, a beam member 30, a first flexible mechanism 40 and a second flexible mechanism 50.

The seat 20 has a seat body 21 and two upright walls 22 respectively fixedly disposed on two ends of the upper face of the seat body 21. Two spaced guide channels 23 are respectively disposed on the upper face of the seat body 21 in parallel to each other, and having a proper length. Two drive members 24 composed of linear motors are respectively disposed on the top ends of the upright walls 22.

The beam member 30 has a first slide member 31 and a second slide member 32. The first and second slide connection members 31, 32 are respectively connected with the drive members 24 and slidable within the guide channels 23. The first and second slide connection members 31, 32 are guided by the guide channels 23 to linearly reciprocally move along a first axis x. The beam member 30 further has a beam body 33 positioned above the seat body 21 between the first and second slide connection members 31, 32. Two ends 331, 332 of the beam body 33 are indirectly bridged between the first and second slide connection members 31, 32 via the first and second flexible mechanisms 40, 50. Accordingly, the beam member 30 is slidably disposed on the seat 20 to linearly reciprocally move along the first axis x.

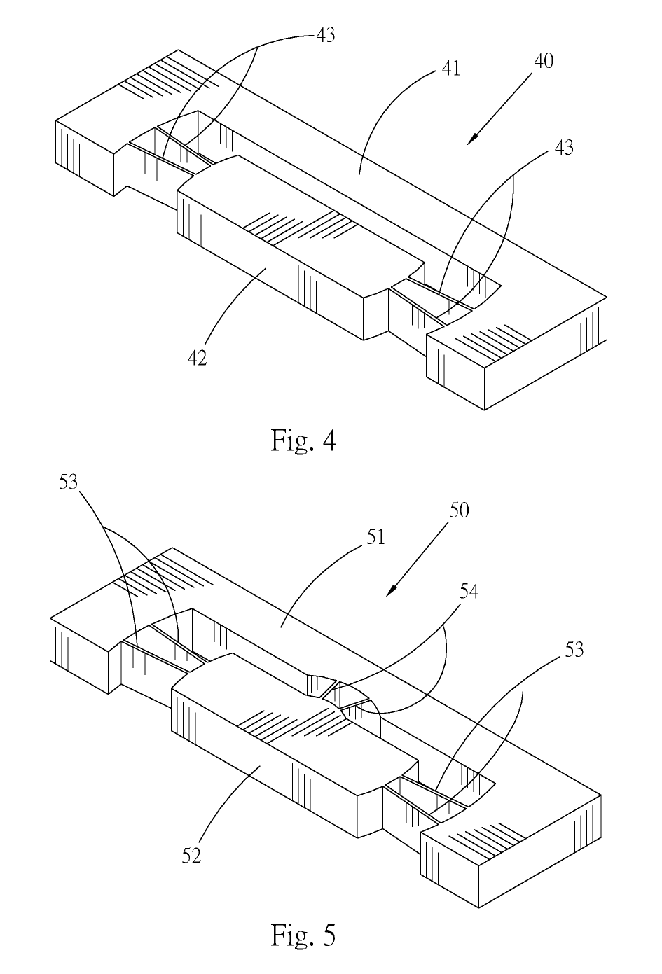

Please refer to FIGS. 2 and 4. The first flexible mechanism 40 has a first connection member 41, a second connection member 42 and first flexible members 43. The first connection member 41 has an open end. The first connection member 41 is fixedly disposed on one end 331 of the beam body 33 with the open end facing to the first slide connection member 31. The second connection member 42 is fixedly disposed on the first slide connection member 31 and positioned in the open end of the first connection member 41. The first flexible members 43 can be elastic leaf springs. Each first flexible member 43 has a lengthwise direction. The lengthwise directions of the first flexible members 43 outward extend to intersect each other at a rotational center of the first flexible mechanism 40. The first flexible members 43 are bridged between the inner wall of the open end of the first connection member 41 and the second connection member 42. The arrangement density of the first flexible members 43 in the direction of the first axis x can be increased to enhance the rigidity of the first flexible members 43 in the direction of the first axis x. Accordingly, when the beam member 30 linearly reciprocally moves along the first axis x, the first flexible members 43 with higher arrangement density can provide higher rigidity in the direction of the first axis x to eliminate the shortcoming of the conventional gantry device.

Please refer to FIGS. 2 and 5. The second flexible mechanism 50 has a third connection member 51, a fourth connection member 52 and third flexible members 53, which are identical to the components of the first flexible mechanism 40. The second flexible mechanism 50 is different from the first flexible mechanism 40 in that the second flexible mechanism 50 further has fourth flexible members 54. The fourth flexible members 54 are positioned on a second axis y. The arrangement density of the fourth flexible members 54 in the direction of the second axis y can be increased to enhance the rigidity of the fourth flexible members 54 in the direction of the second axis y.

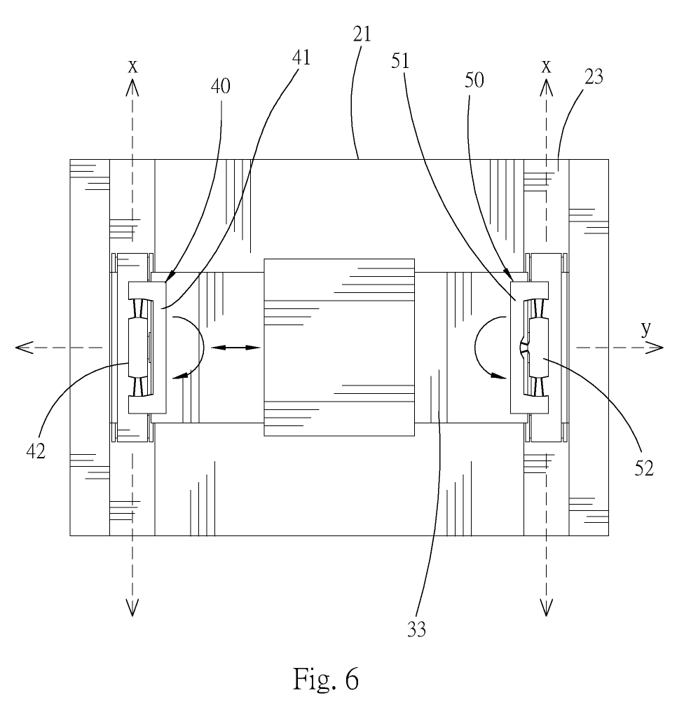

According to the above arrangement, in use of the gantry device 10, the first and third flexible members 43, 53 of the first and second flexible mechanisms 40, 50 serve to enhance the rigidity of the flexible members in the direction of the first axis x. Therefore, when the beam member 30 linearly reciprocally moves along the first axis x, the hysteresis phenomenon of the beam member 30 can be improved. In addition, the rigidity of the non-motional axis of the beam member 30 can be decreased because of the elasticity of the first flexible member 43 and the second flexible member 53. Therefore, as shown in FIG. 6, when the synchronous error of the two ends of the beam member 30 within the guide channels 23 takes place, the beam member 30 is allowed to be shifted under the rotational deformation thereof because of the first flexible mechanism 40 and the second flexible mechanism 50. Therefore, the improper stress caused by the synchronous error of the two ends of the beam member 30 can be avoided. Also, an external control system can be used to control the rotation of the beam member 30.

In addition, when the size of the beam member 30 changes with the temperature change, the extension/retraction direction of the beam member 30 is substantially along the second axis y. The fourth flexible members 54 of the second flexible mechanism 40 serve to provide the deformation in the direction of the second axis y so as to compensate the size change of the beam member 30.

In addition to the above effects, in comparison with the conventional technique, the first flexible mechanism 40 and the second flexible mechanism 50 further have the advantage of smaller volume without occupying too much space and increasing the height. Accordingly, the motional center and the external drive component for supplying power can be positioned on the same horizontal plane to minimize the residual torque.

Furthermore, the means for increasing the rigidity of the flexible members in the direction of the motional axis is not limited to the above embodiments. That is, the rigidity in a specific direction can be increased not only by changing the arrangement density (concentration or distribution) of the flexible members, but also by combining different flexible members with different rigidities.

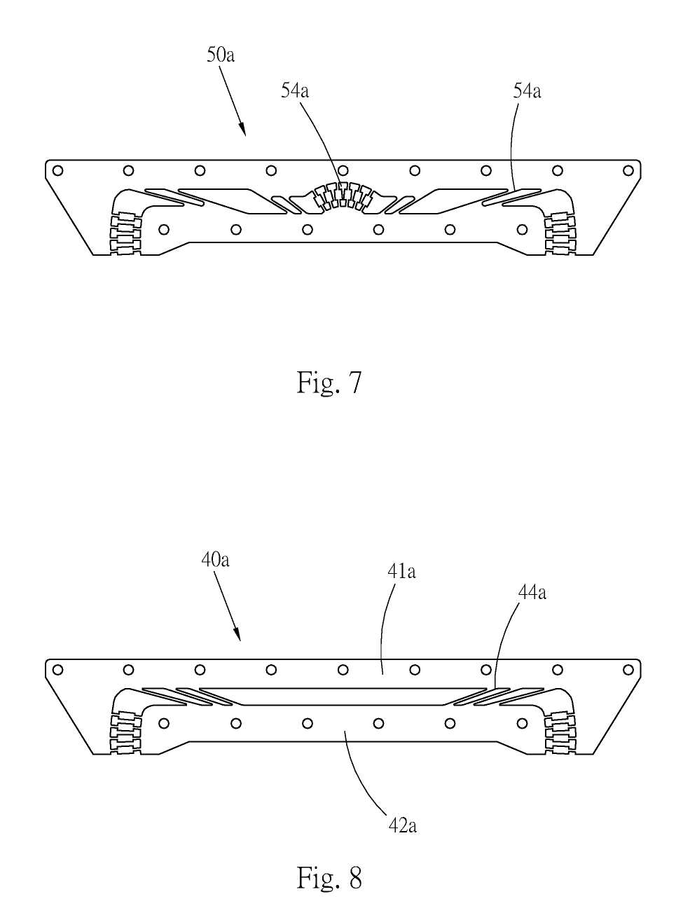

For example, as shown in FIG. 7, the second flexible mechanism 50a has fourth flexible members 54a in a direction different from the direction of the second axis. The arrangement density of the fourth flexible members 54a is smaller than the arrangement density of the fourth flexible members 54a not in the direction of the second axis. Alternatively, FIG. 8 shows another embodiment of the first flexible mechanism 40a. The first flexible mechanism 40a further includes second flexible members 44a positioned in a direction different from the direction of the first axis. The second flexible members 44a are bridged between the first connection member 41a and the second connection members 42a. In other words, the rigidity of the flexible members in the direction of the motional axis can be increased by modifying the number, configuration or the structure of the flexible members.

The above embodiments are only used to illustrate the present invention, not intended to limit the scope thereof. Many modifications of the above embodiments can be made without departing from the spirit of the present invention.

What is claimed is:

1. A flexible mechanism comprising:
a first connection member;
a second connection member spaced from the first connection member, the first and second connection members being relatively movable in the direction of a first axis;
a first flexible member positioned in the direction of the first axis and bridged between the first connection member and the second connection member, the first flexible member being deformable with the relative displacement between the first connection member and the second connection member; and
a second flexible member positioned in a direction different from the direction of the first axis and bridged between the first connection member and the second connection member, the flexible mechanism being characterized in that the rigidity of the first flexible member is larger than the rigidity of the second flexible member for enhancing the anti-deformation ability of the first flexible member in the direction of the first axis.

2. The flexible mechanism as claimed in claim 1, wherein the first connection member has an open end, the second connection member being positioned in the open end of the first connection member, the first and second flexible members being positioned between inner wall of the open end of the first connection member and the second connection member.

3. The flexible mechanism as claimed in claim 1, wherein the first flexible member and the second flexible member are leaf springs.

4. The flexible mechanism as claimed in claim 1, wherein the first connection member and the second connection member are further relatively movable in the direction of a second axis, the rigidity of the second flexible member in the direction of the second axis being larger than the rigidity of the second flexible member in a direction different from the direction of the second axis.

5. The flexible mechanism as claimed in claim 1, wherein the first flexible member and the second flexible member respectively have different thicknesses.

6. A gantry device comprising:
a seat having a seat body, two upright walls, two guide channels and two drive members, the two upright walls being respectively fixedly disposed on two ends of the upper face of the seat body, the two guide channels being respectively disposed on the upper face of the seat body in parallel to each other, the two drive members being respectively disposed on top ends of the upright walls;
a beam member having two slide members and a beam body, the slide members being respectively slidably disposed in the guide channels and connected with the drive members to reciprocally move along a first axis, the beam body being positioned above and the seat body between the two slide members; and
a first flexible mechanism including a first connection member, a second connection member, a first flexible member and a second flexible member, the first connection member and the second connection member being respectively disposed on the beam member and relatively movable, the first flexible member being positioned in the direction of the first axis and bridged between the first connection member and the second connection member, the second flexible member being positioned in a direction different from the direction of the first axis and bridged between the first connection member and the second connection member, whereby when the first connection member and the second connection member are driven by the beam member to be relatively moved, the first flexible member is deformed, the gantry device being characterized in that the rigidity of the first flexible member is larger than the rigidity of the second flexible member for enhancing the anti-deformation ability of the first flexible member in the direction of the first axis.

7. The gantry device as claimed in claim 6, further comprising a second flexible mechanism, the first flexible mechanism and the second flexible mechanism being respectively disposed at two ends of the beam member, the second flexible mechanism including a third connection member, a fourth connection member, a third flexible member and a fourth flexible member, the third connection member and the fourth connection member being respectively disposed on the beam member and relatively movable, the third flexible member being positioned in the direction of the first axis and bridged between the third connection member and the fourth connection member, the fourth flexible member being positioned in a direction different from the direction of the first axis and bridged between the third connection member and the fourth connection member, whereby when the third and fourth connection members are driven by the beam member to be relatively moved, the third flexible member is deformed, the gantry device being characterized in that the rigidity of the third flexible member is larger than the rigidity of the fourth flexible member for enhancing the anti-deformation ability of the third flexible member in the direction of the first axis.

8. The gantry device as claimed in claim 7, wherein the first connection member and the third connection member are respectively fixedly disposed at two ends of the beam body, and the second connection member and the fourth connection member are respectively attached to the slide members.

9. The gantry device as claimed in claim 7, wherein the first connection member and the second connection member of the first flexible mechanism are further relatively movable in the direction of a second axis, the third connection member and the fourth connection member of the second flexible mechanism being further relatively movable in the direction of the second axis, the rigidity of the second flexible member of the first flexible mechanism in the direction of the second axis being unequal to the rigidity of the fourth flexible member of the second flexible mechanism in the direction of the second axis.

10. The gantry device as claimed in claim 7, wherein the first connection member has an open end, the second connection member being positioned in the open end of the first connection member, the first and second flexible members being positioned between inner wall of the open end of the first connection member and the second connection member, the third connection member having an open end, the fourth connection member being positioned in the open end of the third connection member, the third and fourth flexible members being positioned between inner wall of the open end of the third connection member and the fourth connection member.
